(19) United States
(12) Patent Application Publication
(10) Pub. No.: US 2007/0213965 A1
(43) Pub. Date: Sep. 13, 2007

(54) Method and system for preclassification and clustering of chemical substances

(75) Inventors: Anthony J. Trippe, Dublin, OH (US); Karen A. Lucas, Columbus, OH (US); Jeffrey M. Wilson, Columbus, OH (US)

Correspondence Address: FOLEY AND LARDNER LLP;SUITE 500, 3000 K STREET NW, WASHINGTON, DC, 20007, US

(73) Assignee: American Chemical Society

(21) Appl. No.: 11/713,430

(22) Filed: Mar. 2, 2007

Related U.S. Application Data
(60) Provisional application No. 60/780,863, filed on Mar. 10, 2006.
(60) Provisional application No. 60/835,991, filed on Aug. 7, 2006.

(51) Int. Cl. G06G 7/48; G06G 7/58

(52) U.S. Cl. 703/11; 703/12

(57) ABSTRACT

Systems and methods for intuitive visualization of the relationships between molecules. Acyclic and cyclic compounds are converted to base frameworks. The molecules are mapped with each base framework, representing a multitude of molecules, mapped as a single point. The base frameworks are positioned relative to each other using similarity tests as applied to metadata which are associated with the atoms and bonds frameworks of the molecules.

### CROSS REFERENCE TO RELATED APPLICATIONS

This application claims priority from U.S. Provisional Patent Application 60/780,863 filed Mar. 10, 2006 and 60/835,991 filed Aug. 7, 2006, herein incorporated by reference in their entirety.

### BACKGROUND OF THE INVENTION

The invention relates to a system and method for classifying chemical substances based upon an abstraction of their chemical structure and clustering substances having identical abstractions. Metadata regarding the individual chemical substances is associated with a level of abstraction and the chemical substances maybe graphically mapped at a level of abstraction based on the similarity of metadata.

Organization and classification of chemical substances is a necessary and vital component of modern research tools. Current classification systems fail to provide a manner to abstract acyclic substances in a manner to allow for a simplified comparison of substances based on structural similarity. In addition, current systems fail to provide an efficient means for visually representing these structural differences. Furthermore, there is a need for methods and systems that provide a user with a dynamically interactive display of structures and related metadata. Therefore, a need for methods and systems for preclassification and clustering of chemical substances.

### SUMMARY OF THE INVENTION

One embodiment relates to a method for clustering molecules for visualizing relationships between the molecules. The substances from at least one database with a prior classification of substance are represented visually. All substances from the at least one database, with identical frameworks are collected together clustered as a single point, forming a single one point per base framework. Each of the points are mapped in relation to each other based upon metadata associated with the substance.

One embodiment relates to a computer program product for organizing molecules for visualizing relationships between the molecules. Computer program product further includes computer code for representing substances from at least one database with a base framework, for clustering all substances, from the least one database, with identical base frameworks as a single point, forming a single one point per base framework, and for mapping each of the points in relation to each other based upon the metadata.

One embodiment relates to a system for clustering molecules for visualizing relationships between the molecules. The system includes a visual representation of substances from at least one database with a framework, a processing unit for generating a map clustering all of the substances, each cluster on the map arranged in relation to each other based upon metadata associated with the substance, and a display for displaying the map.

One aspect relates to a method for determining a base framework for either a cyclic molecule or an acyclic molecule.

Another aspect relates to systems and methods for representing molecules from at least one database by base frameworks.

These and other objects, advantages, and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

The accompanying drawings, which are incorporated in and constitute a part of the specification, illustrate embodiments of the invention and together with the description, serve to explain the principles of the invention;

FIG. 1 is flowchart describing the steps of one embodiment;

FIG. 2 is a block diagram illustrating the system components of one embodiment;

FIG. 3 is a depiction of a graphical user interface displaying a search performed in a database;

FIG. 4 is a depiction of a graphical user interface displaying the chemical structures included in the results of the search depicted in FIG. 3;

FIG. 5 is a flow chart depicting the steps for converting a cyclic substance into a base framework;

FIGS. 6A-D are a graphical depiction of Thioridazine in 6A) a substance; 6B) an atoms and bonds framework; 6C) an atoms framework; and 6D) a base framework;

FIG. 7 is a flow chart depicting the steps for converting an acyclic substance into a base framework;

FIGS. 8A-D are a graphical depiction of a specific acyclic substance in 8A) a substance; 8B) an atoms and bonds framework; 8C) an atoms framework; and 8D) a base framework;

FIG. 9 is a depiction of a graphical user interface displaying a workspace display in one embodiment, the workspace displaying comprising individual windows;

FIG. 10 is a map visualizing the relationships of substances in accordance with the principles of an embodiment;

FIG. 11 illustrates a close-up view of a section of the map of FIG. 8;

FIG. 12 illustrates a framework display depicting base frameworks for the substances displayed in the map of FIG. 9;

FIG. 13 illustrates a framework display depicting atoms and bonds frameworks for the substances displayed in FIG. 12;

FIG. 14 is a depiction of a graphical user interface displaying a substance display;

FIG. 15 is a depiction of a detailed substance display for a substance in the display of FIG. 11;

FIG. 16 is a depiction of a labels display as used for the substance display of FIG. 14;

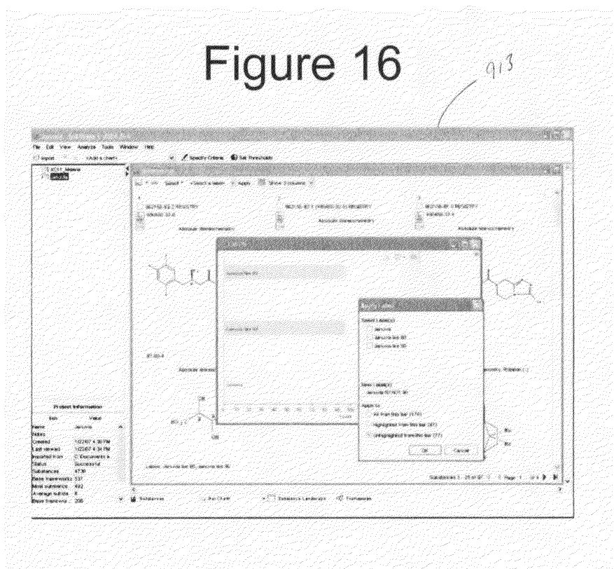

FIG. 17 is a two-dimensional matrix chart relating bioactivity for each of the atoms and bonds frameworks in one embodiment;

FIG. 18 is a view of a research landscape display for illustrating documents in one embodiment;

FIG. 19 is a view of a three-dimensional research landscape display for illustrating documents in one embodiment;

FIG. 20 is a display of a one-dimensional bar chart depicting document data in one embodiment; and

FIG. 21 is a two-dimensional matrix chart depicting document data in one embodiment.

### DETAILED DESCRIPTION OF THE EMBODIMENTS

In a general aspect, the invention involves dynamically and graphically relating chemical structures to metadata and providing a dynamic display of the relationships between the chemical structures and the associated metadata. In general, such systems and methods allow for an intuitive method of analyzing the relationships of a large number of chemical structures, such as from a library or database. A user is able to quickly ascertain compounds which have similar chemical structures as well as chemical structures that exhibit similar metadata such as bioactivity or physical properties.

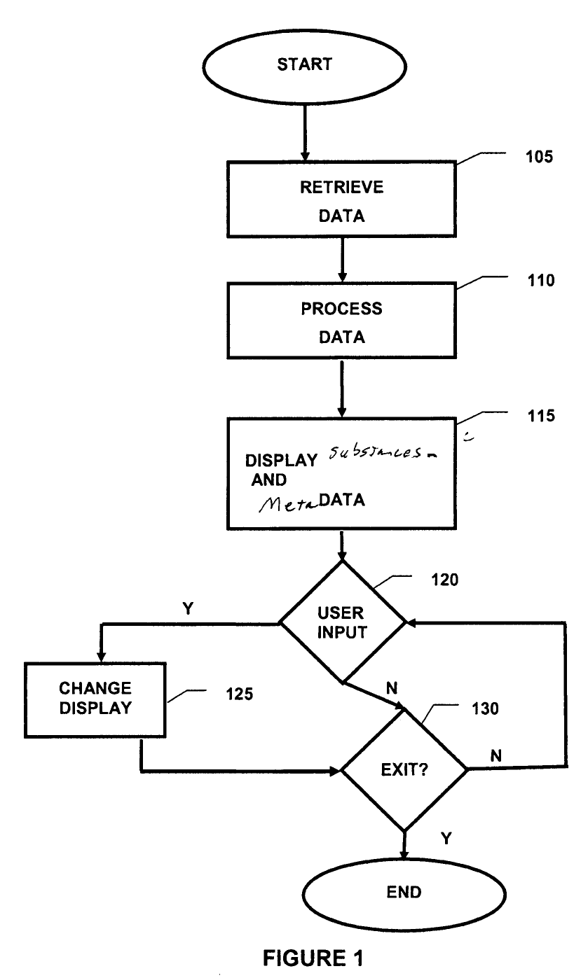

Referring now to the Figures, exemplary systems and methods for visualizing relationships of substances in two dimensional space are shown. FIG. 1 is a flowchart that illustrates the process flow in one embodiment in which meaningful data is retrieved and presented to a user.

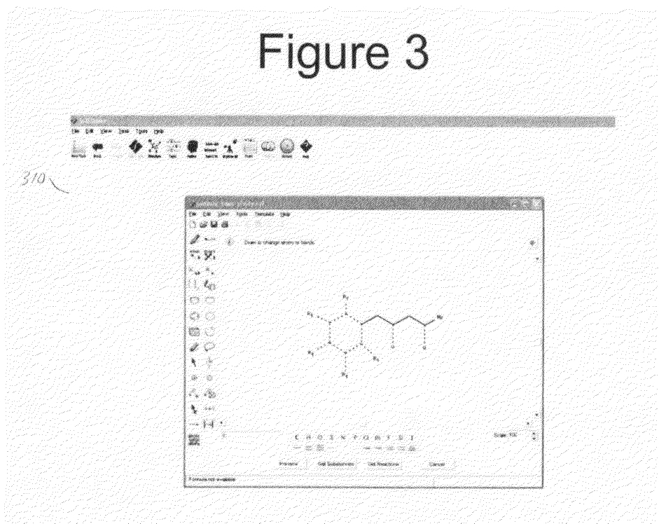

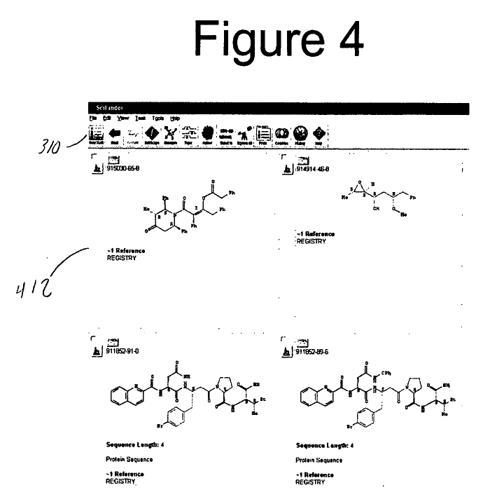

A library or database (such as commercial databases or a company's proprietary database) may be used to provide information regarding substances for use with the systems and methods described herein. In one embodiment, the database is searchable by a user to define a universe of chemical compounds for display and analysis using the described systems and methods. It should be appreciated that the searching of the database may be a separate function, such as a separate computer software program, or may be a function integral to the systems and methods as further described below. FIG. 3 depicts a graphical user interface displaying an interface for searching a database. FIG. 4 illustrates a graphical user interface displaying the results of the search depicted in FIG. 3. These results are the substances define the universe of substances relating to the performed search. These substances then define the universe of substances for analysis as further described below.

The substances contained in the database may be real, prophetic, or virtual (in silico). Such information may include the specific structure of the substance, i.e., the information, graphically and/or textually, regarding the interrelation of each atom of the substance. Such information may also include metadata such as metadata or screens which provide further information regarding certain aspects of the substance as further described below. In one embodiment, more than one database may be used, each providing both listings of substances and their metadata or with certain databases providing lists of substances and certain databases providing the metadata associated with those substances. In another embodiment, a first database may provide the structural information regarding the substances and a second database provides the metadata regarding the substances. One exemplary set of databases that may be used contains printed publications which have been indexed such that substances are associated with metadata, for example the CAS REGISTRY^{SM} file.

The metadata may be descriptors regarding any of a number of attributes associated with the substance, including but not limited to: physical properties of the substance such as boiling point, bioactivity, reactivity with specific reagents, biological data (e.g., bioefficacy, toxicology, binding data, assay data related to one or more targets, medical indications), sourcing or supply data, physicochemical data, patent data, indication of use, mechanism of action, testing data, pharmaceutical applications and pharmacological data, ownership rights, clinical trial data, intellectually assigned taxonomies and ontologies, pre-clinical safety and animal studies, cited references, citing references, physicochemical data, topological torsions, Chemical Abstracts Service structural screens, structural fingerprints including software or computer programs, e.g., ISIS (MDL Information Systems, San Leandro, Calif., http://www.mdli.com); BCI Fingerprint Toolkit (Barnard Chemical Information Systems, Sheffield, UK, http://www.bci.gb.com); Daylight Fingerprint Toolkit (Daylight Chemical Information Systems, Mission Viejo, Calif. http://www.daylight.com), or alternatively, any software or computer program that is suitable for carrying out similar functions.

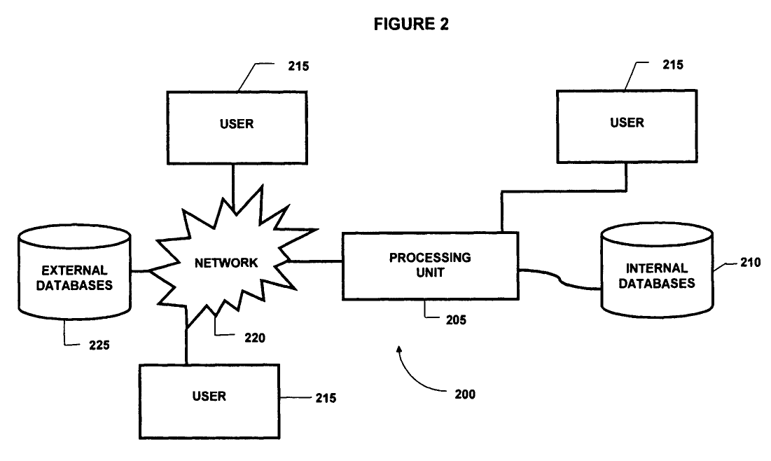

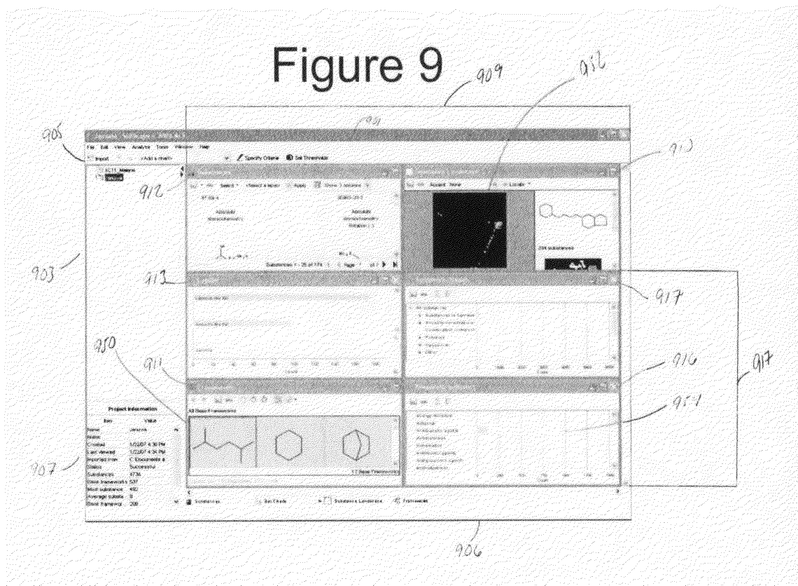

As shown in FIG. 2, the system 200 includes a processing unit 205 (which is a computing system that may be implemented in a distributed architecture) which is programmed to implement the logic of the method steps discussed further herein and includes memory, input-output devices and network connectivity as is well known to those skilled in the art. The processing unit 205 may be accessed by local users 215 or other users 215 over a public or private network 220. The users 215 have a computing unit or terminal including a display unit (not shown) in which multiple display areas may be formatted and displayed (See, e.g., FIG. 9 illustrating workspace 901 having multiple display areas). The processing unit 205 also accesses both internal databases 210 (which means any database that the system has permission to access of its own accord) and may be connected to external databases 225 for which a user permission or login may be required.

With reference to the flowchart of FIG. 1, in step 105, the system (for example, implemented in the processing unit 205) retrieves data including both chemical structures and their corresponding metadata responsive to a user request (for example, a user 215). In certain embodiments, the system provides two methods by which a user 215 can request for the data to be gathered. First, the user 215, may access an external database 225, and retrieve data using the retrieval interface provided by the external database 225. In this situation, the data retrieved from the external database 225 may need to be imported or formatted for use with the system provided herein. For example, the data retrieved from the external databases 225 (or data sources) may be saved in a local file (on the desktop or on a network drive) associated with the user 215 and the system (for example, the processing unit 205) provided herein may then access this file to import the data into the system by formatting the data so that it can be used by the system.

In a second embodiment, the user may use a search or query interface (as best seen in FIG. 3) provided by the system in which the user can access and retrieve data from databases and data sources to which the system is connected (for example, the internal databases 210). In one embodiment, if the search or query interface of the system is used, the data from external or internal databases or data sources is automatically formatted for use with system so that no separate importation or formatting process is necessary. As will be appreciated, a user may use both the first and second methods together to retrieve the data so that the coverage of databases and data sources is maximized.

In step 110, the data that is retrieved responsive to the user's request is processed by the system to provide the interrelated display of the metadata and chemical structures. As will be appreciated, the data may also be requested by more than one user and all the data so requested may be used for the display provided by the system 200. This could be accomplished by, for example, defining groups or projects so that data could be specified by several users and the processing could be done on all the data that is included in a particular group or project.

In one embodiment, it is initially necessary that the data that is retrieved is harmonized so that data that is retrieved from different databases or data sources is treated consistently by the system. For example, the structured fields associated with documents from different databases may have slightly different field names or formats. Therefore, the process of harmonization may change some of these field names to a standard name for fields of a certain type or update a reference table that shows the interrelationships between the different field names so that the subsequent processing of the data treats the similar fields semantically the same way even if the field names or formats are different across the different databases or data sources that are accessed by the system.

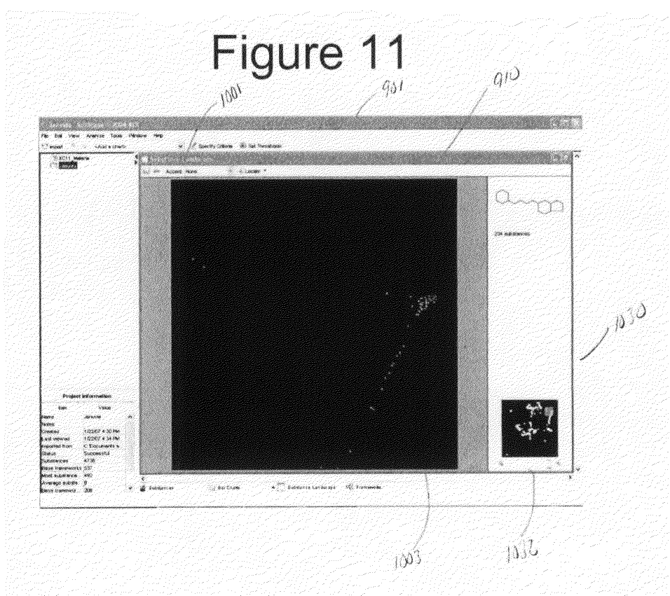

Returning to FIG. 1, in step 110, the data required to format and create the display of the chemical structures (in a first display area) and the display of the metadata (in at least a second display area) are derived. For example, the first display area may display the retrieved chemical structures in a substance landscape map 910 (as best shown in FIG. 11). In one embodiment, the substance landscape map 910 may be a cluster map that displays clusters of the retrieved chemical structures which are clustered based on a similarity value of one or more of the metadata.

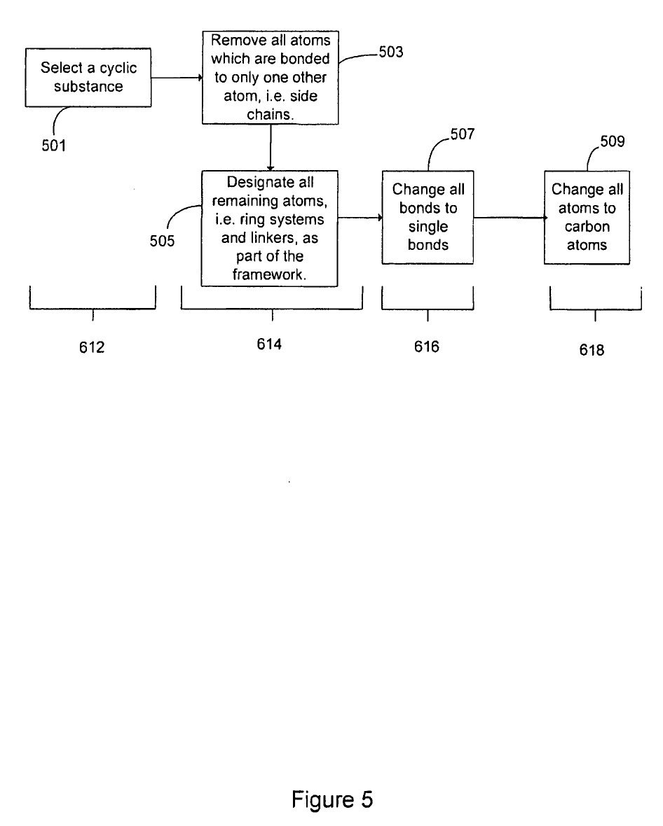

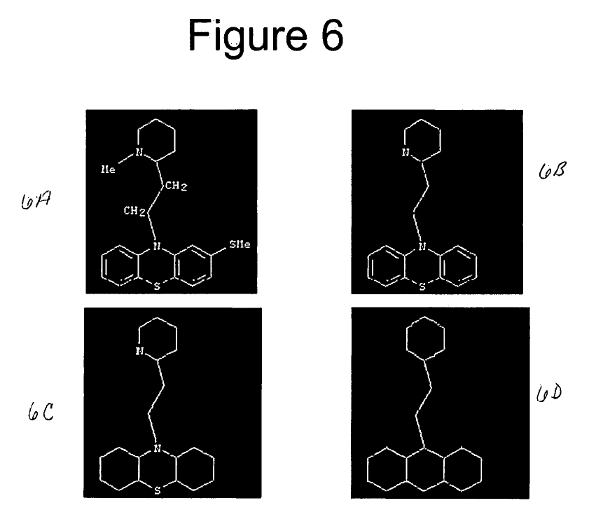

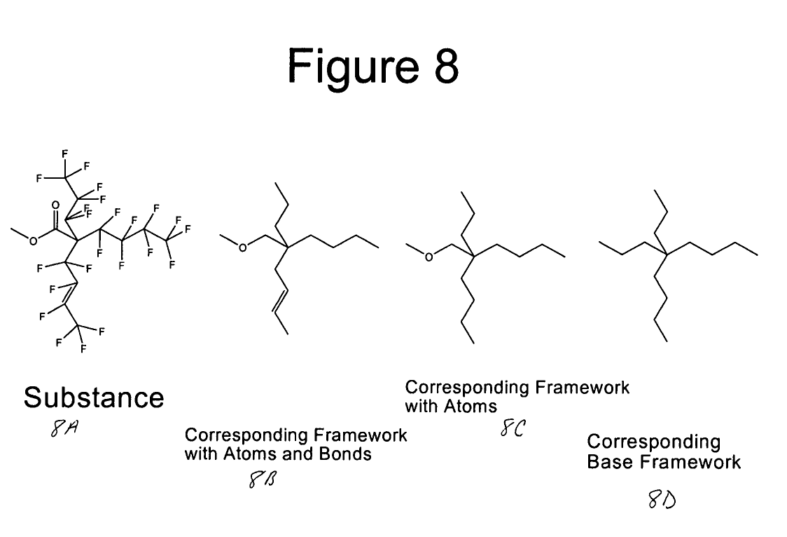

Chemical structures displayed by system 200 may be described or represented, textually or graphically, such as by techniques at several levels of complexity/simplicity. In one embodiment, chemical structures are represented by varying levels of abstraction (See FIGS. 5-8). At the molecular or substance level 612, a particular substance is described by its unique chemical structure. This is typically the basis of prior art searching and analysis methods, information or associated metadata. However, substances can be abstracted out such that a single generalized structure represents a multitude of structurally related substances. For example, FIGS. 6a and 8a illustrate the structures of a cyclic and acyclic substance respectively. The substance is simplified to include only those atoms and bonds which are part of its main structure, represented by an atoms and bonds framework 614 (as best illustrated in FIGS. 6b and 8b). At a more generic level, the substance may be described by an atoms framework 616, wherein all bonds have been reduced to single bonds (as best illustrated in FIGS. 6c and 8c). At an even broader level, the substance may be represented by a base framework 618 where all of the atoms are construed to be carbon (as best illustrated in FIGS. 6d and 8d). These four levels of representation are applicable to both cyclic and acyclic substances. One of ordinary skill in the art will appreciate that a multitude of similar organizational categories can be designed without departing from the spirit of the present invention.

The representation of cyclic substances by a simplified framework form is described in Bemis and Murko, The Properties of Known Drugs. 1. Molecular Frameworks, J. Med. Chem. 1996, 39, 2887-2893, which is hereby incorporated by reference. In cyclic substances, the transformation from substance 612 to atoms and bond framework 614 to atoms framework 616 to base framework 618 is illustrated in FIGS. 5 and 6A-D. FIG. 5 illustrates a flow chart showing the steps to convert a cyclic substance 612 into a base framework 618. At a first step 501, a cyclic substance is selected. Then all of the atoms which are bonded to only one other atom, i.e. side chains, are removed 503. All of the remaining atoms, which constitute the linkers and ring systems, are designated 505 as framework and form the atoms and bonds framework 614. This atoms and bonds framework 614 may be converted to an atoms framework 616, step 505, by changing 507 all of the bonds to single bonds. The base framework 618 is created by changing 509 all atoms in the atoms framework 616 into carbon atoms, step 506.

FIGS. 6A-D illustrate one exemplary embodiment of the various frameworks for the compound Thiordazine. FIG. 6A illustrates the substance 612, FIG. 6B the atoms and bond framework 614, FIG. 6C the atoms framework 616 and FIG. 6D the base framework 618.

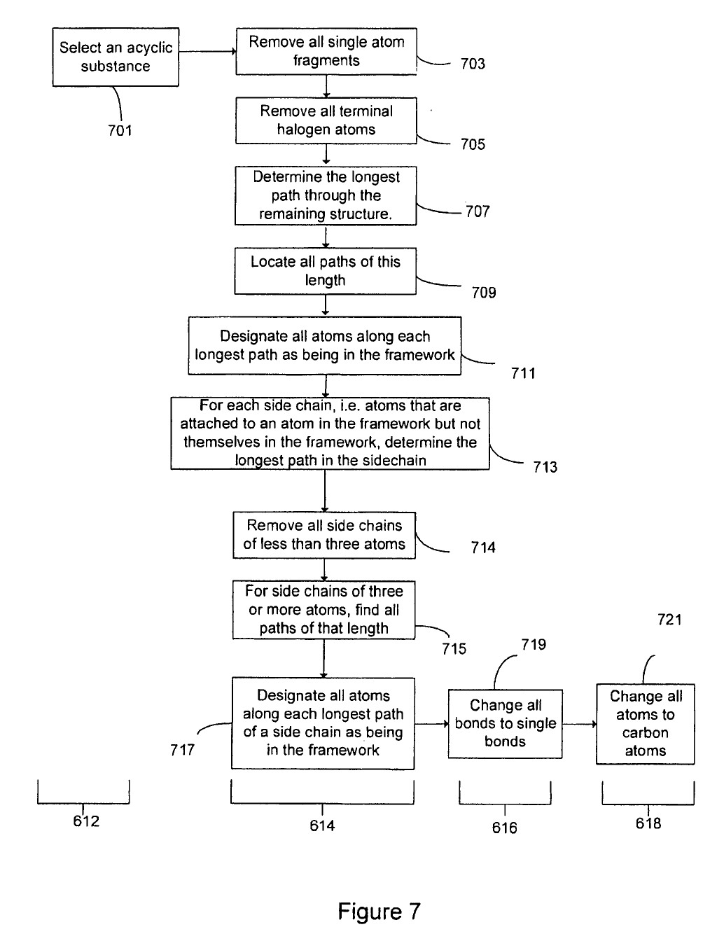

For acyclic substances, the transformation from substance 12 to atoms and bond framework 614 to atoms framework 616 to base framework 618 is illustrated in FIGS. 7 and 8A-D. At a first step 701, a substance 612 is selected. All of atom fragments are removed 703. All of the terminal halogens are removed 705. The longest path through the remaining structure is determined 707. All paths of this length are located 709. All atoms along those paths are designated 711 as being part of the framework. For each side chain, i.e. atoms that are attach to an atom in the framework but not themselves in the framework, the longest path in each of those side chains is determined 713. If the path length of the side chain is less than three atoms, then the atoms of the side chain are removed 714. For the side chains having a path length of three atoms or more, all paths of the longest length for each respective side chain are located 715. All atoms along those paths are designated 717 as part of the framework. This creates the atoms and bonds framework 614. As with the cyclic substances, the atoms and bonds framework 614 is transformed, in step 719, into the atoms framework 616 by changing all of the bonds in the atoms and bonds framework 614 into single bonds. The base framework 618 is created by changing all atoms in the atoms framework 616 into carbon atoms at step 721.

FIGS. 8A-D illustrate one exemplary embodiment of the various frameworks for a specific acyclic substance. FIG. 8A illustrates the substance 612, FIG. 8B the atoms and bond framework 614, FIG. 8C the atoms framework 616 and FIG. 8D the base framework 618.

In one embodiment, a user 215 interacts with system 200 through a graphical user interface to display a workspace. In an exemplary embodiment shown in FIG. 9, a workspace 901 is displayed on the graphical user interface. In certain embodiments, the entire workspace 901 including all the display areas are displayed on the display of a single computing system or other similar display. The workspace 901 provides the user 215 with information regarding the search and includes at least two display windows. FIG. 9 is a depiction of a graphical user interface displaying a workspace 901. One of ordinary skill in the art will appreciate that the layout and contents of the workspace of FIG. 9 is illustrative only and that a multitude of workspace designs may be implemented without departing from the spirit and scope of the present invention. Alternatively, the workspace may be physically distributed over two or more computer displays (or other similar display) so that some of the display areas are displayed on one computer display while the other display areas are displayed on another computer display. However, the display areas are still dynamically interoperable in the manner described herein even if the display areas are physically displayed on different computer or other similar displays. In certain embodiments, a display unit includes a graphical user interface which independently controls and formats the first display area and the second display area. For example, the first display area and the second display area may be separate windows, frames, or panels or combinations thereof which are interoperable in the manner discussed herein.

The workspace 901 of FIG. 9 includes a list of projects 903, a toolbar 905, a shortcut toolbar 906, project information 907 for the currently selected project, and plurality of displays 909. The displays include a substance landscape display 910, a frameworks display 911, a substances display 912, a labels display 913, and metadata displays 914 for bioactivity 916 and substance classes 917.

The list of projects 903 allows a user 215 to switch between projects. In one embodiment the list of recent projects is populated with projects that have been saved locally or on a network.

A “toolbar” functionality may be provided as known in the art. In one embodiment, the toolbar 905 provides actions which affect the workspace 901.

In one exemplary embodiment, a short-cut toolbar 906 is provided. The short-cut toolbar 906 provides a user with functionality to impact only a single specific window in the workspace 901. For example, in one embodiment only a limited number of windows may be shown at once on the workspace 901 and the short-cut toolbar 906 provides a “tab” or other interactive site for representing windows that are not displayed and allowing for those windows to be displayed (such as by automatically replacing a displayed window with the selected, undisplayed window).

The displays 914 provide a user 215 with information regarding the project. Certain displays may illustrate chemical structures at various levels of abstraction, while other windows illustrate metadata related to a selected chemical structure.

In the substance landscape display 910, the chemical structures having similar values for certain data attributes that are related, for example, to the original search queries of the user, are clustered together. Ordination, K-means, and/or other techniques may be used. Some clustering techniques that may be used are: Hierarchical, nearest neighbor, support vector machine, self-organizing maps. Alternatively, the user may separately provide an indication of the metadata that should be used to cluster the chemical structures. Preferably, in addition to the spatial layout data based on the clustering, the system also calculates and uses a measure of the strength of the particular metadata that are used for clustering the substance landscape map. Furthermore, the distance between any two clusters may be an indication of the degree of similarity between the clusters in comparison to the similarity to other clusters.

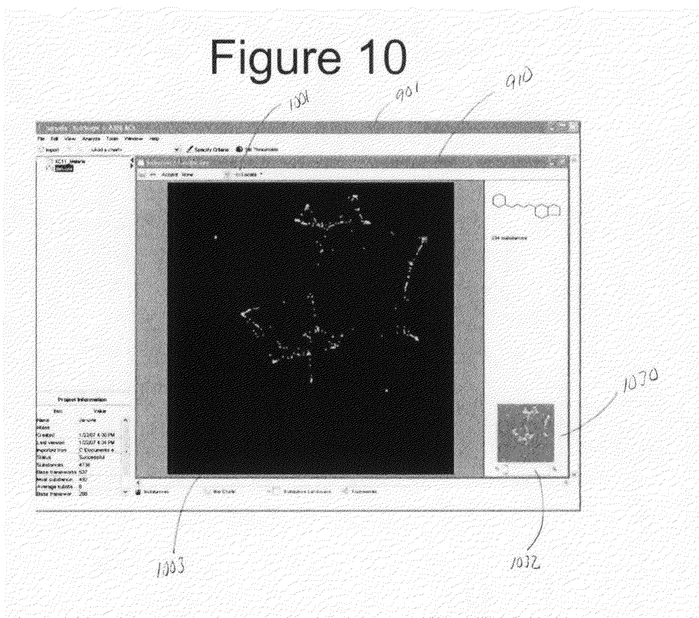

In one embodiment, as shown in FIG. 10, the substance landscape 910 is a graphical representation, or map, of each of the chemical structures or each of a user defined subset of substances in the at least one database is used. Each cluster or unique location 1003 on the map 1001 represents a base framework 618, which itself may represent a cluster of different substances that share the same base framework. The substance landscape allows a user to highlight an individual point or multiple points. For example, where in FIG. 10 the substances are mapped based on their base frameworks, the base framework is of the selected cluster is displayed. In one embodiment, illustrated in FIG. 10, the map 1001 of the substance landscape 910 is displayed on a graphical user interface. The window includes a zoomable map 1030 allowing for display of greater detail of a portion of the entire map 1001, with a landscape navigator display 1032 of the map 1001 displayed in a inset portion of the window substance landscape 910.

FIG. 11 illustrates the substance landscape 910 where a user 215 has zoomed in, thus reducing the scale and allowing for clearer differentiation between clusters. It may be noted that, the mini-map provides an indication of the area which has been zoomed in upon. In an exemplary embodiment, when a point 1003 is selected, the base structure 618 associated with that point 1003 is displayed in a thumbnail viewer 1134.

In one embodiment, each substance has metadata associated with it at the atoms and bonds level. While each of the atoms and bonds frameworks 614 are represented by the same base framework 618, each of the atoms and bonds frameworks 614 exhibit different properties as seen by the metadata. Thus, while each point 1003 on the map 1001 represents a single base framework 618, the points 1003 may be positioned relative to each other based on the aggregate similarities and/or differences of all of the atoms and bonds frameworks 614 which comprise that point 1003 when compared to each other point 1003 (and all of their atoms and bonds frameworks 614).

In one embodiment, each base structure is positioned or mapped using the metadata to place them relative to each other. The positioning using the metadata may be by any of various similarity and/or clustering algorithms, such as but not limited to: Tanimoto, cosine vector, K-means, force directed placement, self-organizing mapping (SOM) hierarchical, nearest neighbor, support vector machine, or combinations thereof.

A map 1001 includes a plurality of points 1003, each representing an individual base framework 618. Points 1003 which are closer in proximity share more similarity in their metadata than points 1003 which are further apart. Thus, points 1003 which are closer are more likely to share similar metadata than points 1003 that are positioned further apart. This provides a user with an easy visualization of the interrelation of the mapped substances. A user is able to judge based on the map 1001 which base frameworks 618, and within them which individual substances, may be of interest. The map 1001 presents a simplified view without overwhelming a user with an unmanageable number of points 1003.

In certain embodiments, the substance landscape display may instead display the chemical structures arranged in a classification scheme in which a structure is classified into one of the categories or groups of the classification scheme.

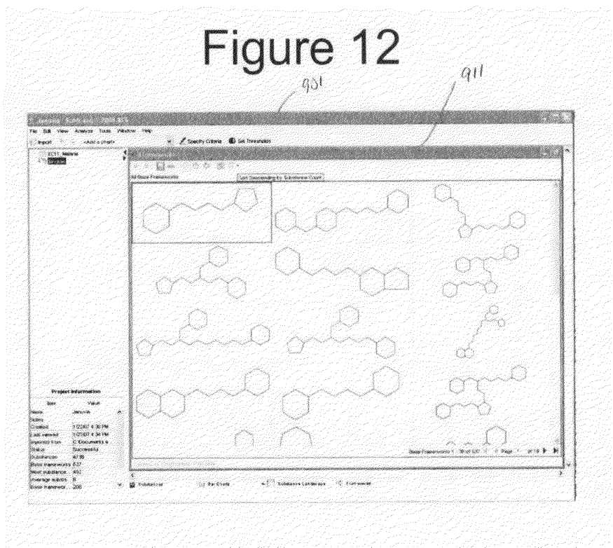

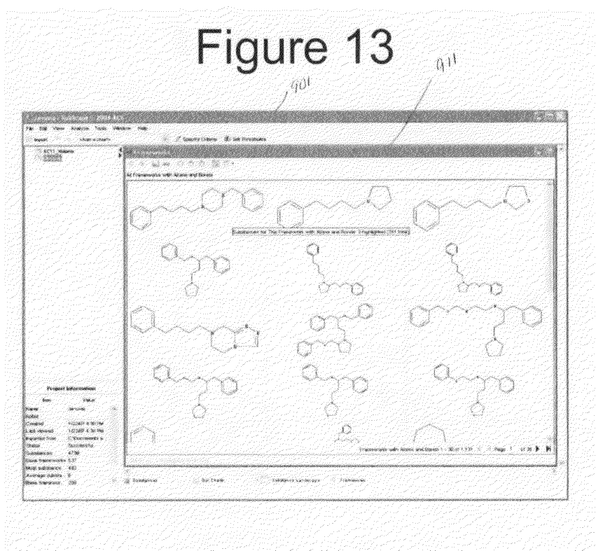

The frameworks display 911 displays frameworks at one of the levels of abstraction described above. FIG. 12 illustrates the frameworks display 911 displaying atom frameworks 616. FIG. 13 illustrates the substances represented by the frameworks display 911 of FIG. 12, but depicting atoms and bonds frameworks 614 (each representing a plurality of actual substances). If a user selects a specific point or points on the map or a specific set of metadata in the metadata displays, the frameworks display 911 is updated to show only those frameworks that correspond to the chosen point or metadata. For example, single point 1003 on the map 1001 of FIG. 10. In one embodiment, each base framework 618 is positioned on the map 1001 in relation to the other base frameworks 618 based upon at least one of the metadata. It will be appreciated by one of ordinary skill that the metadata may be associated with any of the framework levels. For example, a mechanism of action may be associated with the substance, an atoms and bond framework 614, an atoms framework 616, and/or a base framework 618.

The frameworks display 911 may display any of the various levels of frameworks utilized in system 200. For example, the frameworks window may display atoms and bond framework 614, atoms framework 616, or base framework 618. In one embodiment, a user 215 is able to select the level of framework displayed in the framework display 911. The user 215 may also be open an additional window displaying a more detailed level of framework for a selected generic framework in the framework display 911. In this manner, a user 215 is able to “drill down” such as illustrated in FIG. 13 where a user 215 is able to create an atoms and bonds framework 614 for a selected atoms framework in the framework display 911 of FIG. 12. In an exemplary embodiment, the framework display 911 includes a toolbar and an information display, the information display indicating, for example, the number of total substances, the number of frameworks, and the number of highlighted frameworks. The frameworks display 911 may also allow for display of the substance structures or a separate substance display 912 may be provided. In one embodiment, the frameworks display 911 is sortable. The frameworks displayed in the frameworks window are, in an exemplary embodiment, sorted by a default characteristic and a user may select an alternative organization scheme, such as from a pulldown menu.

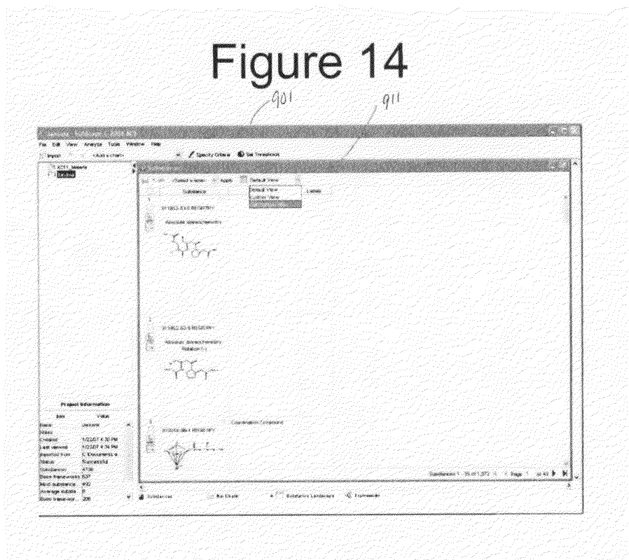

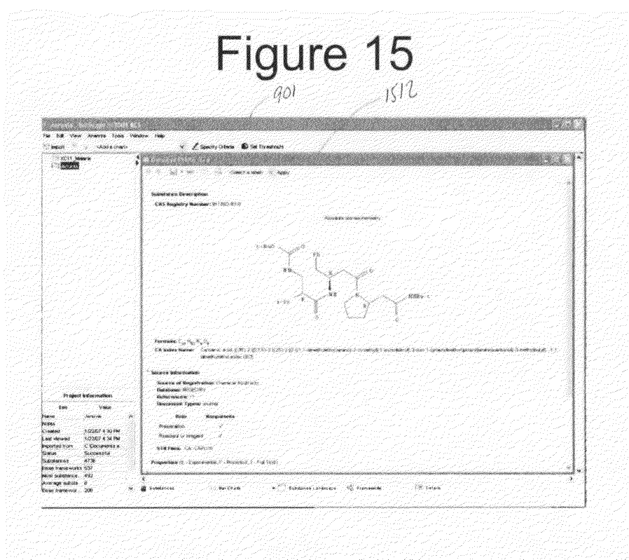

The substance window 912 allows a user to obtain detailed information regarding a substance. As shown in FIGS. 14 and 15, the chemical structure of a substance as well as specific metadata related to that structure at the substance level is displayed. In one embodiment, a user is provided with search functionality to search the universe of substances defined for the project for substances with a similar structure. The search functionality may allow a user to select a degree of similarity. The search results are able to be labeled for later access or display. In one embodiment the substance window 912 provides a user with the option to display a detailed substance window 913, shown in FIG. 15. The detailed substance window 1512 provides a user with information for a selected substance from the substance window 912. In an exemplary embodiment, the detailed substance window 1512 also provides links to documents referencing the substance such as published articles and patents.

Labeling provides the user with functionality to save specific sets of data corresponding to a particular display or search, label them, and access them later. The labels display 913 provides a window for displaying the contents of a labeled group. The workspace 901 allows a user to “flag” or label specific metadata or visual representation so that the label display 913 keeps the flagged data or visual representation irrespective of a selection state of the displays based on a selection or a change in selection of the documents in any one or more of the other display areas.

Metadata displays 914 provide a user 215 with information regarding the metadata associated with chemical structures. The metadata related to the chemical structures needs to be organized so that they can be displayed in one or more display areas (i.e., a second and/or third display area or additional display areas). It should be noted that there could be multiple instances of any one of the display areas discussed herein. Therefore, for example, multiple bar charts (based on different attributes) or multiple substance landscape displays could be provided in certain embodiments. In one embodiment, the metadata related to the chemical structures may be displayed using a one-dimensional display, such as a bar chart.

With reference to FIG. 1, once the data has been processed in step 110, the chemical structure and metadata display are displayed in two or more display areas which may, for example, be the substance landscape 910 and a metadata display 912 respectively (of FIG. 9).

It should be noted that the system 200 provides that these various display areas, for example, the first, second, third and metadata display areas are displayed in a logical workspace. In certain embodiments, the entire workspace including all the display areas are displayed on the display of a single computing system or other similar display. Alternatively, the workspace may be physically distributed over two or more computer displays (or other similar display) so that some of the display areas are displayed on one computer display while the other display areas are displayed on another computer display. However, the display areas are still dynamically interoperable in the manner described herein even if the display areas are physically displayed on different computer or other similar displays. In certain embodiments, a display unit includes a graphical user interface which independently controls and formats the first display area and the second display area. For example, the first display area and the second display area may be separate windows, frames, or panels or combinations thereof which are interoperable in the manner discussed herein.

In step 120, the system checks to see if there is any user input. For example, the user may select one of the clusters in the substance landscape map or one of the attributes displayed in the metadata displays (for example, the bar chart or the matrix display). If there is no input, the system checks to see if the user has indicated that the session should be terminated in step 130 and if not returns to check for user input in step 120.

If user input is detected in step 120, the method proceeds to step 125 in which the displays automatically and dynamically change in response to the user input. For example, if the user selects one of the clusters in the substance landscape map in the first display area, that cluster may be highlighted or otherwise indicated in the substance landscape map in the first display area. The bar chart relating to a first type of metadata in the second display area is also substantially simultaneously updated to reflect the selected cluster in the first display area so that the corresponding data elements in the bar chart are also highlighted or otherwise indicated. Likewise, the bar chart relating to a second type of metadata in the third display area is also substantially simultaneously updated to reflect the selected cluster in the first display area. The metadata in the second and thirds displays is updated to indicate the metadata corresponding to the selected cluster.

It should be noted that while the above discussion discloses that a change in the first display area is automatically and dynamically reflected in the other display areas, the initial change or selection could be made to any one of the display areas and the other display areas would automatically and dynamically change their display in response. For example, metadata corresponding to bioactivity may be displayed. A user is able to select a specific bioactivity such as anti-infective agents and the metadata displayed in any other metadata displays is updated to indicate the respective metadata corresponding to chemical structures exhibiting anti-infective bioactivity. Likewise, the landscape map may be updated to indicate the clusters which exhibit anti-infective bioactivity.

Further details of each of these display areas and their interaction is provided with respect to FIG. 10. FIG. 10 provides an example of a bar chart 930 which is an example of a one-dimensional chart. The bar chart is show in a substance class display. As shown in the bar chart 930, the number of substances corresponding to a given substance classes is displayed. While bioactivity and substance classes have been used as examples in describing the display of the relationship between substances and/or frameworks and associated metadata, it will be appreciated that a wide variety of metadata may be similarly displayed alone or in combinations to provide a user with information regarding the substances. A user can easily change the metadata used for a display. In certain embodiments, the user may right click on an empty area of the display chart to reveal a drop down list which provides the user with the various metadata that may be used to generate the one-dimensional bar chart.

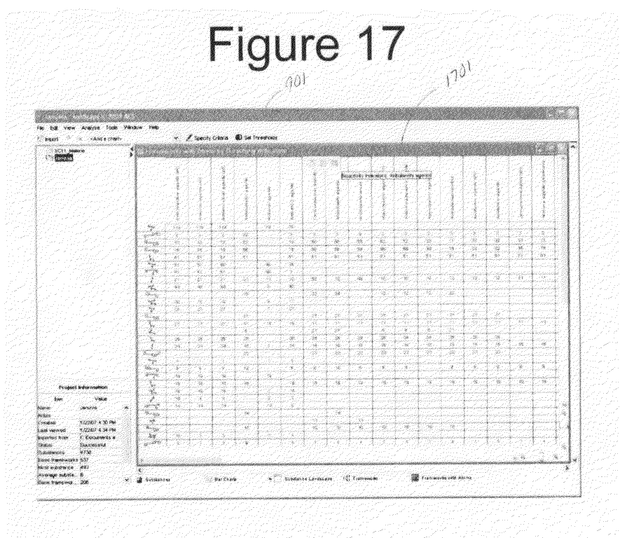

In one embodiment, the metadata displays may be viewed as a two dimensional display area 1701 (shown in FIG. 17). For example, each of the base frameworks may be displayed as rows in the matrix and each of the bioactivities displayed as a column, with the number of substances exhibiting a particular bioactivity in each base framework indicated at the intersection of a row and column.

Therefore, each of the other display areas automatically and dynamically change its display to highlight or indicate data points that correspond to a selected list of documents in any one of the other display areas. Furthermore, whenever the selected data in any one of the display areas is changed, the other display areas also change automatically in substantially the same time to reflect the changes in the one display area (for example, based on the changed selection of documents). Therefore, a user can easily visually analyze not only the documents in a substance landscape map but also the attributes associated with specific selected documents selected in the substance landscape map 910.

FIG. 9 is an example of the dynamic automatic interoperation between the various display areas of the system 700. The display area shows a landscape map 910 for all substances retrieved from various databases responsive to a search for the term “januvia”. As can be seen from the project information panel 907, the search returned 4259 substances, represented by 920 unique base frameworks. The single largest group of substances represented by a single base framework is 490, with the average being 8. If the user selects one of the clusters related to base framework of interest, the selected cluster is highlighted on the landscape map 910 and shown in the display area. Substantially simultaneously the display in the other displays 909 also automatically change to reflect the selected state in the display area. In the embodiment shown in FIG. 9, the displays 909 are updated to indicate which of the information they display relate to the highlighted base framework 950 in the base framework display 911 and which relate to the universe of substances as defined by the search. In this embodiment, the corresponding clusters in the cluster map are highlighted 952. Likewise, the displays which provide information regarding certain pieces of metadata such as the bioactivity display and the substance classes display are updated to indicate with a first color 954 the number of compounds that correspond to the selected cluster and a second color 956 corresponding to the entire search. Therefore, in appropriate displays 907, portions of each of the bars in the bar charts are highlighted to indicate the proportion of documents that correspond to the selected state of the cluster 1003 in and thereby provide an indication of the metadata that correspond to the selected cluster 1003 in display area 1210. Of course, bars that do not have any of the metadata corresponding to the selected cluster are not highlighted at all.

While embodiments have been described providing clustered structures and metadata associated with those structures, in an exemplary embodiment certain metadata may be associated with text such as documents from a database. For example, a document display map area may display clusters of documents which are clustered based on a similarity value of one or more concept indicators. The concept indicators may be associated with each document retrieved by being stored as metadata related to that document. For example, a document vector may be stored associated with each document in which the elements of the vectors indicate the presence and/or strength of one or more of the concept indicators. If the retrieved data (or documents) do not have metadata available apriori, the system may generate such metadata by reviewing the attributes of the document, for example, by using text mining software that reviews the keywords associated with the document or looks for the presence or absence of specific word sequences in the text of the documents.

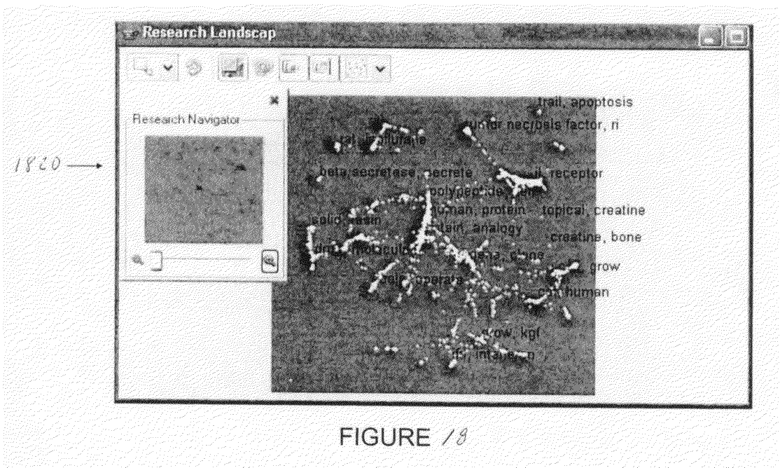

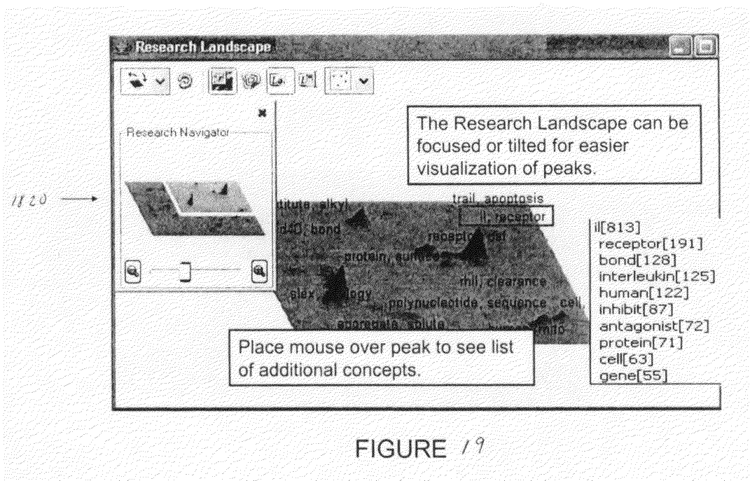

In an exemplary embodiment best illustrated in FIG. 18, a document landscape display 1820 is provided to present a visual representation of the document clustering (FIG. 18), the data or documents having similar values for certain data attributes that are related, for example, to the original search queries of the user, are clustered together. Alternatively, the user may separately provide an indication of the concept indicators that should be used to cluster the unstructured data or documents. Preferably, in addition to the spatial layout (FIG. 18) data based on the clustering, the system also calculates and uses a measure of the strength of the particular concept indicators that are used for clustering the research landscape map. Accordingly, the document landscape map 1820, in certain embodiments such as shown in FIG. 19, uses a three or more dimensional display to provide an indication of the number and/or strength of the data (or documents) that make up a particular cluster. Therefore, for example, a cluster with many documents may be indicated by a greater height peak than a cluster with fewer documents that are displayed as a cluster having a lower height peak when compared to the cluster having a larger number of documents. Furthermore, the distance between any two clusters may be an indication of the degree of similarity between the clusters.

The workplace 901 may further comprise one or more windows for displaying information related to the documents. In one embodiment, a document viewer is provided in which any one of the individual documents can be viewed as text. When none of the documents is selected for viewing, the document viewer may show a list of the documents that can be sorted using indexes of interest to a user.

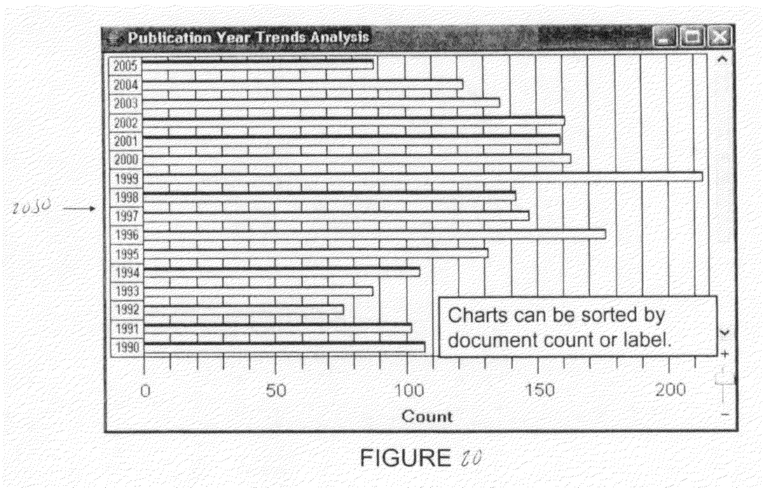

Display area 2030 (shown in FIG. 20) is an example of a one-dimensional display (a bar chart) in which information about the documents are displayed together with one attribute of interest associated with the documents. For example, if the documents are patents, the display area 2030 may be used to display the key organizations that own the patents and the bars in the bar chart indicate the number of patents assigned to each organization. The display area 2030 may be provided as a window in the workplace 901.

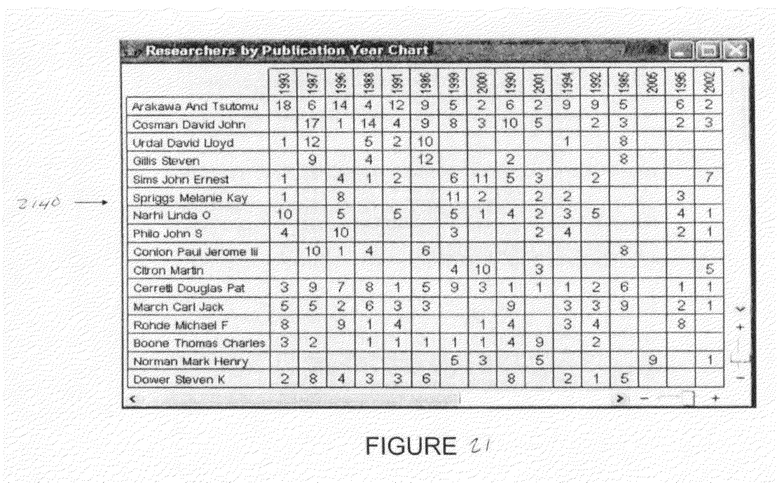

Display area 2140 (shown in FIG. 21) is an example of a two-dimensional display (a matrix chart) in which information about the documents are displayed together with two attributes associated with the documents. For example, if the documents are patents, the display 2140 may be used to display all the key organizations that own these patents together with the publication year associated with the documents. In this way, the display area not only provides information on which organizations are most involved in the documents or patents in the answer set but also the time frame in which these documents or patents have been published. The display area 2040 may be provided as a window in the workplace 901.

In certain embodiments, the system 200 provides that two or more selections (such as two or more clusters on the substance landscape 910) can be active in the selected or highlighted state in one or more of the display areas. If two sets of data are to be displayed in a single display area (based on the fact that there are two active selected states), the data corresponding to each of the selections could be color coded to be different or the brightness of the data could be varied to reflect which selected state the data corresponds. Data that belongs to both selected states could be easily tracked by displaying a third color that may correspond to a combination of the colors for the other two selected states.

The displays may have further functionality as well. In one embodiment, the user 215 interacts with the displays via a pointing tool such as a mouse. A tooltip may be displayed when the user 215 directs the pointing tool to a particular part of a display, for example hovering the pointing tool over a cluster in the landscape map will display the number of substances represented by that cluster. In another embodiment, the user is able to interact with the display such as by activating button on the mouse to bring up a menu display. The menu display may present options to the user 215 that relate to other displays. For example, a user may be able to “right click” on a framework in the framework display and the corresponding clusters on the landscape map are indicated.

Furthermore, it should be appreciated that it is within the abilities of one skilled in the art to program and configure a networked computer system to implement the method and system discussed earlier herein. One embodiment also contemplates providing computer readable data storage medium with program code recorded thereon (i.e., software) for implementing the method steps described earlier herein. Programming the method steps discussed herein using custom and packaged software is within the abilities of those skilled in the art in view of the teachings disclosed herein. Furthermore, it should be recognized that data signals that embody one or more of the software instructions to implement the method disclosed herein are also within the scope of the present invention.

Other embodiments of the invention will be apparent to those skilled in the art from a consideration of the specification and the practice of the invention disclosed herein. It is intended that the specification be considered as exemplary only, with such other embodiments also being considered as a part of the invention in light of the specification and the features of the invention disclosed herein. Furthermore, it should be recognized that the present invention includes the methods and system disclosed herein together with the software and systems used to implement the methods and systems disclosed herein.

What is claimed is:

1. A method for clustering substances for visualizing relationships between the substances, the method comprising:
representing substances with a framework representing an abstraction of their structure;
organizing substances with identical frameworks as a single point, forming a single one point per framework; and
visually mapping each of the points in relation to each other based upon metadata associated with the substances.

2. The method of claim 1, wherein the metadata is associated with a specific level of framework, such that the mapping clusters the points based on the aggregate similarities between all of the frameworks of the specific level.

3. The method of claim 2, wherein the level of framework is chosen from the group consisting of base frameworks, atoms frameworks, and atoms and bonds frameworks.

4. The method of claim 3, wherein the metadata is associated with an atoms and bonds framework associated with a substance.

5. The method of claim of claim 4, wherein each point visually corresponds to a single base framework which represents at least one of the substances.

6. The method of claim 1, wherein the substances comprise both acyclic and cyclic molecules.

7. The method of claim 4, wherein the levels of frameworks for acyclic substances are constructed by:
removing all single atom fragments from the substance;
removing all terminal halogen atoms from the substance;
determining the longest path length through the substance;
locating all paths which have a path length equal to the longest path length and designating them as being in the framework, with the remaining atoms each being a side chain or a portion of a side chain;
determining for each side chain the longest path length through the side chain which includes an atom designated as a portion of the longest path of the structure;
removing all of the atoms of each side chain if the if the longest path length of the respective side chain is less than three atoms;
locating all of the paths of each side chain which have a path length equal to the longest path length through the respective side chain; and
designating all atoms which are part of a longest path through a side chain as being in the framework,
wherein the marked atoms and their bonds comprise the atoms and bonds framework representing the acyclic substance's structure.

8. The method of claim 5, further comprising changing all bonds to single bonds forming an atoms framework.

9. The method of claim 8, further comprising changing all atoms of the structure to carbon, forming a base framework.

10. The method of claim 1, wherein the metadata comprises a descriptor selected from the group consisting of topological torsions, structural screens, and structural fingerprints.

11. The method of claim 1, wherein the metadata is a structural descriptor which describes at least one structural characteristic.

12. The method of claim 11, wherein the at least one structural descriptor comprises at least one of the Chemical Abstracts Service structural screens.

13. The method of claim 1, wherein the mapping is performed using a process selected from the group consisting of ordination, K-means, hierarchical, nearest neighbor, support vector machine, and self-organizing maps.

14. A method of representing an acyclic structure of a compound as a framework, the method comprising:
removing single atom fragments from the structure;
removing terminal halogen atoms from the structure;
determining the longest path length through the structure;
locating paths which have a path length equal to the longest path length and designating them as being in the framework, with the remaining atoms each being a side chain or a portion of a side chain;
determining for each side chain the longest path length through the side chain which includes an atom designated as a portion of the longest path of the structure;
removing of the atoms of each side chain if the if the longest path length of the respective side chain is less than three atoms;
locating of the paths of each side chain which have a path length equal to the longest path length through the respective side chain; and
designating atoms which are part of a longest path through a side chain as being in the framework,
wherein the marked atoms and their bonds comprise the framework representing the acyclic compound's structure.

15. The method of representing an acyclic compound structure of claim 10 further comprising changing bonds to single bonds.

16. The method of representing an acyclic compound structure of claim 10 further comprising changing atoms of the structure to carbon.

17. A computer program product for organizing molecules for visualizing relationships between the molecules, comprising:
computer code for visually representing substances from at least one database with a base framework;
computer code for clustering all substances, from the least one database, with identical base frameworks as a single point, forming a single one point per base framework; and
computer code for mapping each of the points in relation to each other based upon the metadata.

18. The computer program product of claim 17, further comprising computer code for associating the metadata with a specific level of framework, such that the mapping places the points based on the aggregate similarities between all of the framework of the specific level.

19. The computer program product of claim 18, further comprising computer code for selecting the level of framework is chosen from the group of levels consisting of base frameworks, atoms frameworks, and atoms and bonds frameworks.

20. The computer program product of claim 19, wherein the substances comprise both acyclic and cyclic molecules.

21. The computer program product of claim 20, further comprising computer code for constructing the levels of frameworks for acyclic substances by:
removing all single atom fragments from the substance;
removing all terminal halogen atoms from the substance;
determining the longest path length through the substance;
locating all paths which have a path length equal to the longest path length and designating them as being in the framework, with the remaining atoms each being a side chain or a portion of a side chain;
determining for each side chain the longest path length through the side chain which includes an atom designated as a portion of the longest path of the structure;
removing all of the atoms of each side chain if the if the longest path length of the respective side chain is less than three atoms;
locating all of the paths of each side chain which have a path length equal to the longest path length through the respective side chain; and
designating all atoms which are part of a longest path through a side chain as being in the framework,
wherein the marked atoms and their bonds comprise the atoms and bonds framework representing the acyclic substance's structure.

22. The computer program product of claim 21, further comprising computer code for changing all bonds to single bonds forming an atoms framework.

23. The computer program product of claim 22, further comprising computer code for changing all atoms of the structure to carbon, forming a base framework.

24. The computer program product of claim 21, wherein the metadata comprises a plurality of alphanumeric terms.

25. The computer program product of claim 24, wherein the metadata is a structural descriptor which describes at least one structural characteristic.

26. The computer program product of claim 25, wherein the at least one structural descriptor comprises at least one of the Chemical Abstracts Service structural screens.

27. A system for clustering molecules for visualizing relationships between the molecules, comprising:
a visual representation of substances from at least one chemical with a framework;
a processing unit for generating a map clustering all of the substances, each cluster on the map arranged in relation to each other based upon metadata associated with the substance; and
a display for displaying the map.

28. The system of claim 27, wherein the metadata is associated with a specific level of framework, such that the mapping places the points based on the aggregate similarities between all of the framework of the specific level.

29. The system of claim 28 wherein the level of framework is chosen from the group of levels consisting of base frameworks, atoms frameworks, and atoms and bonds frameworks.

30. The system of claim 29, wherein the molecules comprise both acyclic and cyclic molecules.

31. A method for clustering substances for visualizing relationships between the substances, the method comprising:
searching a database for substances responsive to a set of search parameters;
retrieving a list of substances responsive to the searching;
visually representing the substances from at least one database with a level of framework selected from the levels consisting of base frameworks, atoms frameworks, and atoms and bonds frameworks;
clustering substances as base frameworks, substances having identical base frameworks represented as a single point; and
mapping each of the points in relation to each other based upon metadata associated with the atoms and bonds frameworks of the substances.

32. The method of claim 31, wherein the substances comprise both acyclic and cyclic molecules.

33. The method of claim 32, wherein the levels of frameworks for acyclic substances are constructed by:
removing all single atom fragments from the substance;
removing all terminal halogen atoms from the substance;
determining the longest path length through the substance;
locating all paths which have a path length equal to the longest path length and designating them as being in the framework, with the remaining atoms each being a side chain or a portion of a side chain;
determining for each side chain the longest path length through the side chain which includes an atom designated as a portion of the longest path of the structure;
removing all of the atoms of each side chain if the if the longest path length of the respective side chain is less than three atoms;
locating all of the paths of each side chain which have a path length equal to the longest path length through the respective side chain; and
designating all atoms which are part of a longest path through a side chain as being in the framework,
wherein the marked atoms and their bonds comprise the atoms and bonds framework representing the acyclic substance's structure.

34. The method of claim 33, further comprising changing all bonds to single bonds forming an atoms framework.

35. The method of claim 34, further comprising changing all atoms of the structure to carbon, forming a base framework.

36. The method of claim 31, wherein the metadata comprises a plurality of alphanumeric terms.

37. The method of claim 36, wherein the metadata is a structural descriptor which describes at least one structural characteristic.
